(19) United States
(12) Patent Application Publication
(10) Pub. No.: US 2013/0044827 A1
(43) Pub. Date: Feb. 21, 2013

(54) Communications Via Power Line and a Hardware Implementation

(71) Applicants: Marius Vladan, Oudenaarde (BE); Stefan Van Roeyen, Sint-Niklaas (BE); Steve Hoste, Scheldewindeke (BE); Jean-Francois Koleck, Gavere (BE); Luc D'haeze, Orroir (BE); Romeo Iacobut, Oudenaarde (BE)

(72) Inventors: Marius Vladan, Oudenaarde (BE); Stefan Van Roeyen, Sint-Niklaas (BE); Steve Hoste, Scheldewindeke (BE); Jean-Francois Koleck, Gavere (BE); Luc D'haeze, Orroir (BE); Romeo Iacobut, Oudenaarde (BE)

(73) Assignee: BROADCOM CORPORATION, Irvine, CA (US)

(21) Appl. No.: 13/211,187

(22) Filed: Aug. 16, 2011

(51) Int. Cl. H04B 3/00

(52) U.S. Cl. 375/257

(57) ABSTRACT

Provided is a communication protocol for communication via power line. For example, there is a power supply equipment for communication via a power line including a controller, a power line input coupled to the power line, and a current demodulator coupled to the power line input and the controller. The controller is configured to demodulate a first portion of a power signal of the power line at the power line input using the current demodulator and to receive a first bitstream over the power line. A second bitstream may be provided by the controller in order to modulate a voltage sent from the power supply equipment to a powered device via the power line. The powered device may further demodulate the modulated voltage to extract the second bitstream sent from the power supply equipment.

### BACKGROUND OF THE INVENTION

1. Field of the Invention

The present invention relates generally to data communications. More particularly, the present invention relates to data communications via power line.

2. Background Art

The contemporary proliferation of electronic devices has strained almost all aspects of traditional power distribution infrastructure, from public utility capacity serving entire geographical regions to the number and spacing of power receptacles in a typical home. In particular, cabling used to couple a typical collection of electronic devices to each other and to their powering devices often poses a clutter problem as well as a frustrating reminder of the general inefficiency prevalent with such cabling.

For example, typical electronic devices come with individualized and relatively inexpensive powering devices. Such conventional powering devices typically only supply a single power level at all times, and so are a constant “phantom power” drain on household electricity. In aggregate, such conventional powering devices are responsible for a significant portion of public utility capacity, increasingly as more electronic devices enter daily life.

To address these concerns, there have been attempts to develop more intelligent power delivery systems, and power delivery systems that reduce cable clutter. But, these conventional power delivery systems are typically unable to fully manage power delivery between power supplies and loads due to communication times being limited to particular powering phases (e.g., a classification phase, for example, or only after fully powering a load) and due to an inability to communicate more general power management information. Moreover, these conventional power delivery systems often incorporate complex and high level communication protocols, such as a link layer discovery protocol for example, that are relatively expensive to implement and coordinate efficiently.

Accordingly, there is a need to overcome the drawbacks and deficiencies in the art by providing a communication protocol for communication via power line that is relatively inexpensive and simple to implement but that can actively communicate detailed operational data between powering and powered devices without having to rely on separate data lines or particular powered states.

### SUMMARY OF THE INVENTION

The present application is directed to data communication via power line, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system implementing a communication protocol for communication via power line, according to one embodiment of the present invention;

FIG. 2 presents a flowchart illustrating a method implementing a communication protocol for communication via power line, according to one embodiment of the present invention.

FIG. 3 presents a flowchart illustrating a method implementing a communication protocol for communication via power line, according to another embodiment of the present invention.

### DETAILED DESCRIPTION OF THE INVENTION

The present application is directed to a communication protocol for communication via power line. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. Unless noted otherwise, like or corresponding elements among the figures may be indicated by like or corresponding reference numerals. Moreover, the drawings and illustrations in the present application are generally not to scale, and are not intended to correspond to actual relative dimensions.

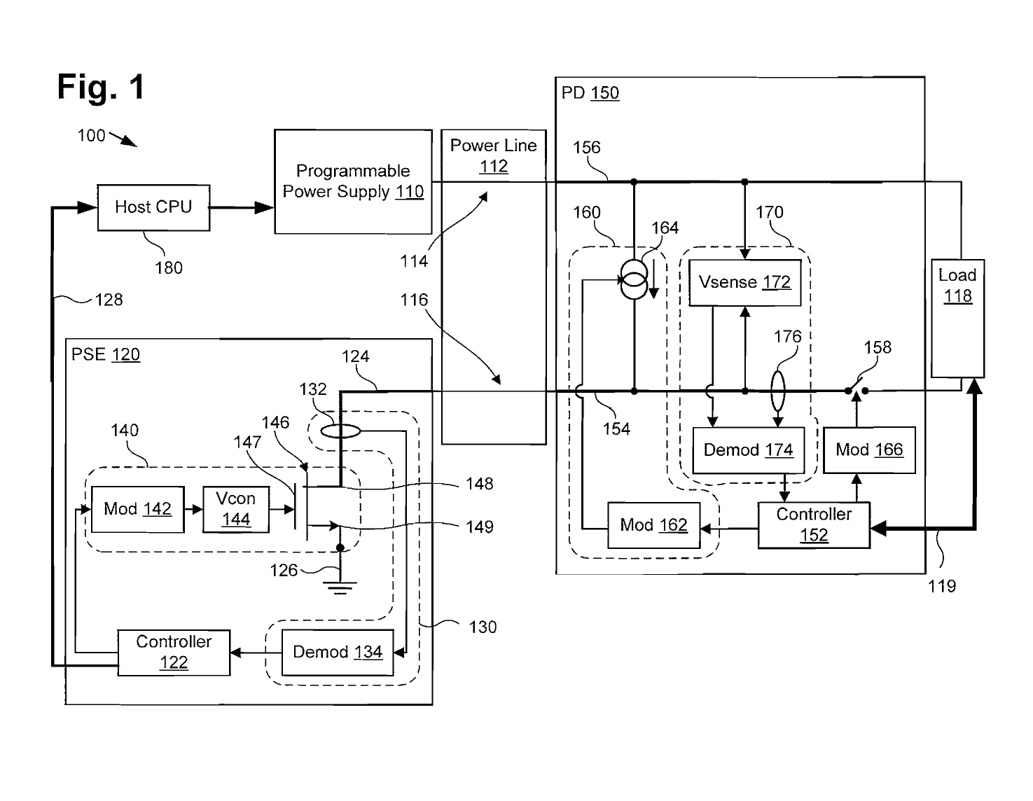

FIG. 1 shows power delivery system 100 illustrating an embodiment of the present inventive concepts addressing the concerns described above. As shown in FIG. 1, System 100 includes programmable power supply 110, power line 112, load 118, power sourcing equipment (PSE) 120, powered device (PD) 150 as well as an optional host CPU 180. In typical operation, programmable power supply 110 and PSE 120 may be configured to utilize power line 112 to power and communicate with PD 150, which in turn may be configured to power load 118, according to a state of switch 158, as well as communicate with PSE 120 using the same power line 112. Although the embodiment of the present inventive concepts depicted by FIG. 1 shows programmable power supply 110 as physically separate from PSE 120, in other embodiments, power supply 110 may be incorporated into PSE 120, for example.

Programmable power supply 110 may comprise any device or circuit capable of providing power to one or more other devices, for example, over a power line. For instance, programmable power supply 110 may be configured to supply a variety of voltage levels, for example, as well as a variety of current limits, for example, to meet power needs of PD 150, load 118, or both. In some embodiments, programmable power supply may also be configured to provide DC or AC power, for example, depending on such needs. As shown in FIG. 1, programmable power supply 110 may be configured to accept control signals from PSE 120, for example, over control line 128. Such control signals over control line 128 may comprise analog control signals, for example, or digital data. In one embodiment, controller 122 may optionally provide a control signal to a host CPU 180 via control line 128, wherein host CPU 180 provides further processing of the control signal and outputs a processed control signal to programmable power supply 110, for example. It should be understood that in an embodiment where host CPU 180 is not incorporated, control line 128 may provide control signals from controller 122 directly to programmable power supply 110, for example.

Also shown in FIG. 1 is power line 112, which may comprise two or more conductors, for example, and may be configured to couple supply power 112 from programmable power supply 110 to PD 150, for example, and to couple power signal 116 from PD 150 to PSE 120. In the embodiment illustrated by FIG. 1, supply power 114 may represent a “source” side of power supplied by programmable power supply 110 to PD 150, for example, and power signal 116 may represents a “sink” side of power sunk by PSE 120. For instance, if programmable power supply 110 were configured to supply a DC power of 5V limited to 100 mA to PD 150, supply power 112 may represent an electrical signal comprising approximately 5 VDC at 50 mA and power signal 116 may represent an electrical signal comprising approximately 0 VDC at 50 mA, as will be explained more fully below. Supply power 114 and power signal 116 may each reside on a single conductor of power line 112, for example, or may reside on separate bundles of conductors in order to reduce a cable loss due to a length of power line 112. Additionally, although not shown in FIG. 1, power line 112 may comprise additional conductors (not shown in FIG. 1) that may be configured to transmit data between devices utilizing system 100, for example. For instance, power line 112 may comprise a network cable, such as a CAT 6 Ethernet cable, for example, where two of its conductors are utilized by system 100 and the remaining conductors are used to facilitate networking between, for example, a network switch (not shown in FIG. 1) and load 118. As such, system 100 may be configured to form a portion of a power-over-Ethernet (PoE) power distribution system, for example.

Load 118 may comprise any device able to accept power from programmable power supply 110 and power line 112, for example. For instance, load 118 may comprise a network device, for example, such as a network switch, router, internet protocol (IP) phone, or IP camera, for example, which may be particularly beneficial where power line 112 comprises an Ethernet cable configured both to power load 118 and to network load 118 with other network devices.

PSE 120 of system 100 in FIG. 1 may comprise any device able to provide a voltage sink for programmable power supply 110, for example, and that can be configured to communicate with a powered device, such as PD 150, via power line 112. As shown in FIG. 1, PSE 120 may comprise controller 122, power line input 124 coupled to power line 112 and able to access power signal 116, voltage sink 126, current demodulator 130 and voltage modulator 140. PSE 120 may be configured to communicate with devices coupled to power line 112 using transmitted and received bitstreams, for example, as will be explained more below. In alternative embodiments, PSE 120 may lack either current demodulator 130 or voltage modulator 140, for example, and only communicate unidirectionally with other devices. In some embodiments of PSE 120, PSE 120 may be coupled to programmable power supply 110 by control line 128, for example, which may be configured to control a supply power produced by programmable power supply 110.

Current demodulator 130 may comprise any device or circuitry capable of sensing a current modulation of at least a portion of power signal 116, for example, and demodulating such current modulation so as to provide a bitstream encoded in the current modulation to controller 122. For example, as shown in FIG. 1, in some embodiments, current demodulator 130 may comprise current sensor 132 coupled to power line input 124 and demodulator 134 coupled to current sensor 132 and controller 122. Current sensor 132 may comprise a loop sensor configured to sense changes in a current of power signal 116, for example. Demodulator 134 may comprise any device or circuitry capable of accepting an output of current sensor 132 including a current modulation and providing a bitstream encoded in the current modulation to controller 122.

Such modulation may comprise any modulation scheme capable of encoding a bitstream, for example, such as amplitude modulation, frequency or phase modulation, or any variety of digital modulation such as PSK, FSK, ASK and QAM, for example. A bitstream may be any binary encoding of data, for example, such that any associated modulation scheme may be primarily concerned with encoding representations of binary data. For example, in one embodiment, a modulation scheme may comprise two different current levels, where current sensor 132 may be configured to sense transitions from high to low and low to high and demodulator 134 may be configured to assign “zero” bits to high to low transitions and “one” bits to low to high transitions, for example. In some embodiments, current demodulator 130 may utilize the same modulation scheme as voltage modulator 140, for example, but in other embodiments, they may use different modulation schemes, depending on a capability of controller 122, for example.

Controller 122 may comprise any device or circuitry, for example, capable of being configured to demodulate a current modulation of power signal 116 using current demodulator 130, for example, and/or to produce a voltage modulation of power signal 116 using voltage modulator 140, for instance, and correspondingly receive and transmit bitstreams encoded into respective current modulations and voltage modulations. In particular, controller 122 may be configured to accept received bitstreams from current demodulator 130, for example, and provide bitstreams for transmission utilizing, for example, voltage modulator 140. For example, controller 122 may be configured to demodulate at least a first portion of power signal 116 at power line input 124 using current demodulator 130, for example, thereby receiving a bitstream over power line 112 as described above. In addition, or alternatively, controller 122 may be configured to modulate at least a second portion of power signal 116 at power line input 124 using voltage modulator 140, for example, thereby transmitting a bitstream over power line 112. In some embodiments, such first and second portions of power signal 116 may comprise time-differentiated or frequency-differentiated portions of power signal 116, for example, or any other differentiation method that can be used to facilitate two-way communications using, for example, controller 122, current demodulator 130 and voltage modulator 140.

In some embodiments, controller 122 may comprise a logic block, for example, that is capable of performing some processing of a received bitstream, for example, and providing bitstreams for transmission corresponding to a processing of a received bitstream. For example, controller 122 may be configured to accept a bitstream comprising a received supply power, or supply power 114 measured at PD 150, for example, and then to use the received supply power to calculate a cable loss for power line 112. Controller 122 may then be further configured to use such cable loss, for example, to adjust programmable power supply 110 and produce supply power 114 accounting for the cable loss. In other embodiments, controller 122 may be configured to accept a bitstream comprising a requested supply power, or a particular supply power 114 measured at programmable power supply 110, for example, and then to use the requested supply power to adjust programmable power supply 110 to produce the requested supply power for power line 112. In still other embodiments, controller 122 may be configured to accept a bitstream comprising an identification data, such as an identification data identifying PD 150 and its typical supply power requirements, for example, and then to use the identification data to adjust programmable power supply 110 to produce a particular supply power, such as supply power 114 for example, associated with the identification data. As such, in some embodiments, controller 122 may include a look up table or the like to compare identification data and retrieve a particular supply power associated with the identification data.

As noted above, in some embodiments of the present inventive concepts, controller 122 may be coupled to voltage modulator 140, which may comprise any device or circuitry capable of forming a voltage modulation of power signal 116 at power line input 124 and transmitting a bitstream over power line 112. In particular, voltage modulator 140 may be configured to form a voltage modulation of power signal 116 that does not interfere with operation of PD 150 and/or load 118. In some embodiments, voltage modulator 140 may comprise a switch resistance modulator, for example, configured to modulate a voltage of power signal 116 using a relatively small switch resistance coupled to power line input 124 and voltage sink 126.

For example, as shown in FIG. 1, in some embodiments, voltage modulator 140 may comprise modulator 142, variable voltage source 144 and transistor 146. Modulator 142 may comprise any device or circuitry capable of accepting a bitstream from controller 122 and encoding the bitstream into a modulated control signal, for example, to be provided to variable voltage source 144. Variable voltage source 144 may, in turn, comprise any device or circuitry capable of accepting a modulated control signal from modulator 142, for example, and producing a corresponding modulated control voltage for gate 147 of transistor 146. In some embodiments, variable voltage source 144 may be configured to produce a modulated control voltage for gate 147 such that the modulated control voltage modulates a relatively small effective drain-source resistance of transistor 146 (e.g., an effective resistance measured between drain 148 and source 149, for example) while it is substantially in an “on” state (e.g., an R_{DS}(on) of transistor 146). Drain 148 and source 149 may be coupled to power line input 124 and voltage sink 126, for example, thereby enabling voltage modulation of power signal 116 by a corresponding resistance modulation of an R_{DS}(on) of transistor 146. Such voltage modulation of power signal 116 may, in turn, enable transmission of a corresponding bitstream over power line 112. While transistor 146 is shown in FIG. 1 as coupled serially between power line input 124 and voltage sink 126, in other embodiments, transistor 146 may instead be coupled in parallel, for example, or using additional circuit elements, for instance, to reduce a power dissipation in transistor 146. In some embodiments, transistor 146 may comprise an N-channel or P-channel MOSFET, for example, and may additionally comprise a power MOSFET.

Although voltage sink 126 is depicted as a circuit ground in FIG. 1, in other embodiments, voltage sink 126 may comprise a negative voltage terminal, for example, to facilitate a floating power supply architecture, for example. Moreover, while voltage sink 126 is shown as being internal to PSE 120, in other embodiments, voltage sink 126 may be external to PSE 120, for example, such that power signal 116 passes through PSE 120 and is terminated through another power line similar to power line 112, for example, or through another type of power line. In all such embodiments, PSE 120 may still be configured to communicate with other devices via power line 112 and the methods described herein.

Also shown in FIG. 1 is PD 150. PD 150 of system 100 in FIG. 1 may comprise any device able to interface with supply power 114 and power signal 116 and communicate with a PSE, such as PSE 120 for example, via power line 112. As depicted in FIG. 1, PD 150 may comprise controller 152, power line output 154 coupled to power line 112 and able to access power signal 116, power line input 156 coupled to power line 112 and able to access supply power 114, load switch 158, current modulator 160 and complex demodulator 170. Complex demodulator 170 is denoted “complex” for the reason that it may comprise a device capable of demodulating either voltage modulated or current modulated signals. In the alternative, complex modulator may simply comprise a device capable of demodulating only voltage modulated signals, in which case complex demodulator 170 would simply function as a voltage demodulator. PD 150 may be configured to communicate with devices coupled to power line 112 using transmitted and received bitstreams, for example, as will be explained more fully below. In alternative embodiments, PD 150 may lack either current modulator 160 or complex demodulator 170, for example, and only communicate unidirectionally with other devices.

Controller 152 of PD 150 in FIG. 1 may comprise any device or circuitry, for example, capable of being configured to produce a current modulation of power signal 116 using current modulator 160, for example, and/or to demodulate a voltage modulation or current modulation of power signal 116 using complex demodulator 170, for instance, and correspondingly transmit and receive bitstreams encoded into respective current modulations and voltage modulations. In particular, controller 152 may be configured to provide bitstreams for transmission utilizing current modulator 160, for example, and to accept received bitstreams from, for example, complex demodulator 170. For example, controller 152 may be configured to modulate at least a first portion of power signal 116 at power line output 154 using current modulator 160, for example, thereby transmitting a bitstream over power line 112. In addition, or alternatively, controller 152 may be configured to demodulate at least a second portion of power signal 116 at power line output 154 using complex demodulator 170, for example, thereby receiving a bitstream over power line 112. In some embodiments, such first and second portions of power signal 116 may comprise time-differentiated or frequency-differentiated portions of power signal 116, for example, or any other differentiation method that can be used to facilitate two-way communications using, for example, controller 152, current modulator 160 and complex demodulator 170. Furthermore, similar to current demodulator 130 and voltage modulator 140 of PSE 120 described above, current modulator 160 and complex demodulator 170 of PD 150 may utilize any number of modulation schemes, and may utilize the same or differing modulation schemes, for example, depending on a capability of controller 152.

In some embodiments, controller 152, like controller 122 above, may comprise a logic block, for example, that is capable of performing some processing of a received bitstream, for example, and providing bitstreams for transmission corresponding to a processing of a received bitstream. For example, controller 152 may be configured to accept a bitstream comprising an identification data, such as an identification data identifying PSE 120 and a supply power range for programmable power supply 110, for example, and then to use the identification data to produce a bitstream requesting a particular supply power (e.g., a requested supply power) within the supply power range for programmable power supply 110. As such, in some embodiments, controller 152 may include a look up table or the like to compare identification data and retrieve a particular supply power range associated with the identification data. In other embodiments, controller 152 may be configured to transmit a bitstream comprising an identification data identifying PD 150 and its typical supply power requirements, for example. In still other embodiments, controller 152 may be configured to produce a bitstream comprising a received supply power, for example, measured by voltage sensor 172, for instance. Regardless of the contents of such bitstreams, controller 152 may be configured to use current modulator 160 to transmit any number of such bitstreams to other devices coupled to power line 112.

Current modulator 160 may comprise any device or circuitry capable of forming a current modulation of power signal 116 at power line output 154, for example, and transmitting a bitstream over power line 112. In particular, current modulator 160 may be configured to form a current modulation of power signal 116 that does not interfere with operation of PD 150 and/or load 118. For example, as shown in FIG. 1, in some embodiments, current modulator 160 may be coupled to power line output 154, power line input 156 and controller 152, and may comprise modulator 162 and variable current source 164. Modulator 162 may comprise any device or circuitry capable of accepting a bitstream from controller 152 and encoding the bitstream into a modulated control signal, for example, to be provided to variable current source 164. Variable current source 164 may, in turn, comprise any device or circuitry capable of accepting a modulated control signal from modulator 162, for example, and producing a corresponding modulated current, for instance, thereby enabling current modulation of power signal 116 and transmission of a corresponding bitstream over power line 112. It should be understood that variable current source 164, though shown in FIG. 1 as embedded in PD 150, may alternatively be embedded in load 118, for example, thus being connected to power line output 154 through load switch 158.

PD 150 may utilize complex demodulator 170 to receive bitstreams over power line 112, similar to how PSE 120 may utilize current demodulator 130 to receive bitstreams over power line 112. As stated above, complex demodulator 170 may comprise any device or circuitry capable of sensing a voltage modulation, and/or optionally a current modulation, of at least a portion of power signal 116, for example, and demodulating such voltage and/or current modulation so as to provide a bitstream encoded in the voltage and/or current modulation to controller 152. For example, as shown in FIG. 1, in some embodiments, complex demodulator 170 may comprise voltage sensor 172 coupled to power line output 154, power line input 156 and demodulator 174 coupled to voltage sensor 172 and controller 152. Complex demodulator 170 may also optionally comprise current sensor 176, disposed in series with load switch 158, and coupled to demodulator 174, for example. Voltage sensor 172 may comprise any device or circuitry capable of sensing a voltage difference between, for example, power line input 156 and power line output 154, for example, and thereby to sense a voltage difference between supply power 114 and power signal 116. Likewise, current sensor 176 may comprise any device or circuitry capable of sensing a current modulation on power line output 154, for example. Demodulator 174 may in turn comprise any device or circuitry capable of accepting an output of voltage sensor 172 including a voltage modulation, and/or an output of current sensor 176 including a current modulation, and providing a bitstream encoded in the voltage and/or current modulation to controller 152.

Also shown in FIG. 1 is load switch 158, which may be a MOSFET, for example, and may be coupled to controller 152 via modulator 166 and configured to selectively couple load 118 to power line output 154 and, thus, to power line 112. Modulator 166 may comprise any device or circuitry capable of accepting a bitstream from controller 152 and encoding the bitstream into a modulated control signal, for example, to be provided to load switch 158. In some embodiments, controller 152 may be configured to use load switch 158 to couple load 118 to power line 112 while PD 150 is transmitting and receiving bitstreams over power line 112, for example. In other embodiments, controller 152 may be configured to couple load 118 to power line 112 only when PD 150 is not communicating directly with another device coupled to power line 112, such as PSE 120, for example. For example, in some embodiments, controller 152 of PD 150 may be coupled to load 118 directly through interface line 119, for example, which may comprise a digital interface with load 118, for instance. Utilizing interface link 119, controller 152 may be notified when load 118 does not need power, for example, and controller 152 may use load switch 158 to decouple load 118 from power line 112, for instance, and/or notify PSE 120 of a reduced need for power in order to enable a power saving feature of system 100.

By using a simplified structure such as that shown in FIG. 1, embodiments of the present inventive concepts leverage inexpensive circuitry to enable very robust communication between powering and powered devices that may be active before, during and after a load device is powered. Furthermore, such active communication can take place without requiring a link layer discovery protocol implementation, as can be seen from the above. A lack of such requirement further simplifies an overall communication protocol according to the present inventive concepts, leading to additional manufacturing cost savings, and enables active communication independent of other communication links, such as an Ethernet link for example. In addition, as can be seen from the above, embodiments of the present inventive concepts provide fine power control and other power saving features, as well as active power management by a PSE, a PD, or both.

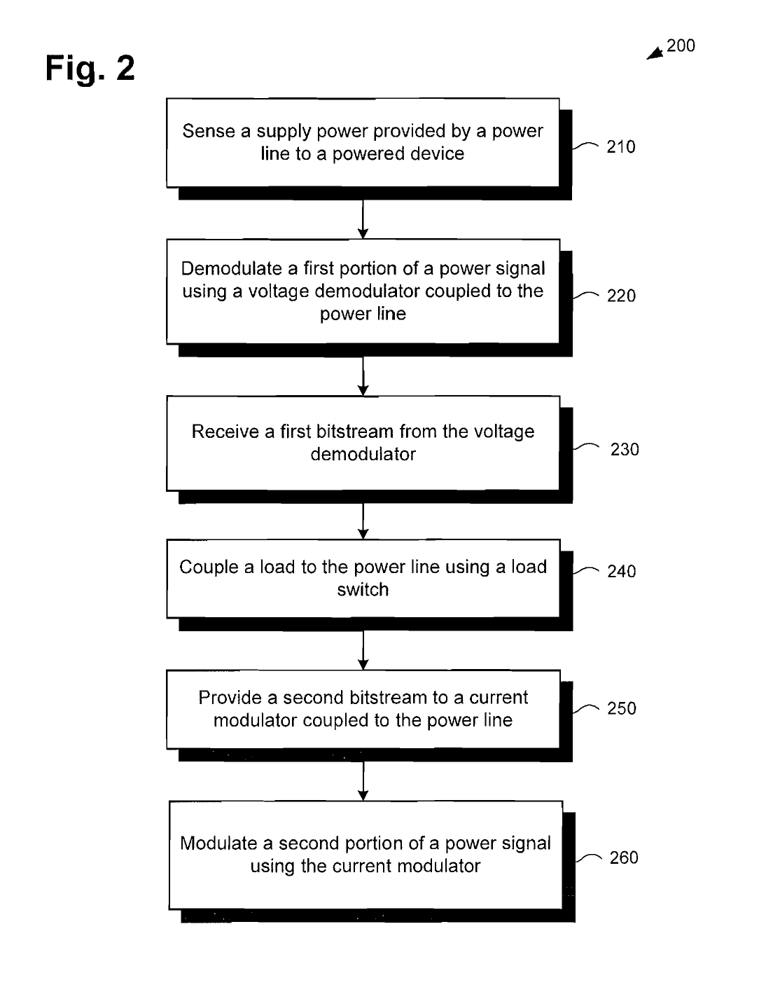

Turning to FIG. 2, FIG. 2 shows flowchart 200 illustrating a method for a controller of a PD for communication via a power line, such as controller 152 of PD 150 communicating via power line 112, for example. Certain details and features have been left out of flowchart 200 that are apparent to a person of ordinary skill in the art. For example, a step may consist of one or more substeps or may involve specialized equipment or materials, as known in the art. Steps 210 through 260 indicated in flowchart 200 are sufficient to describe one embodiment of the present invention; however, other embodiments of the invention may make use of steps different from those shown in flowchart 200. It is noted that FIG. 1 illustrates a system capable of performing the method of flowchart 200, and so steps 210 through 260 are described with reference to system 100 in FIG. 1.

Referring now to step 210 of the method embodied in FIG. 2, step 210 of flowchart 200 comprises controller 152 sensing supply power 114 provided by programmable power supply 110 via power line 112 to PD 150. For example, controller 152 may be configured to use voltage sensor 172 of complex demodulator 170 to sense supply power 114, for example, when power line 112 is connected to PD 150, for instance, utilizing power line output 154 and power line input 156.

Continuing with step 220 in FIG. 2, step 220 of flowchart 200 comprises controller 152 demodulating a first portion of power signal 116 using complex demodulator 170 coupled to power line 112. As explained above, such first portion may be differentiated from other portions of power signal 116, for example, utilizing any differentiation method that can be used to facilitate two-way communications between devices coupled to power line 112. Furthermore, any type of demodulation method may be used by demodulator 174 of complex demodulator 170, for example, that can produce a bitstream encoded in a voltage modulation sensed by voltage sensor 172. Moving to step 230 in FIG. 2, step 230 of flowchart 200 comprises controller 152 receiving a first bitstream from complex demodulator 170. As described previously, demodulator 174 may be configured to provide a bitstream encoded in a voltage modulation sensed by voltage sensor 172, for example, such that controller 152 receives the bitstream. In some embodiments, a received bitstream may comprise active management data transmitted by, for example, PSE 120, where the active management is configured to provide power saving for system 100, for instance. By being configured to repeat steps 220 and 230 periodically, for example, embodiments of the present inventive concepts may receive multiple bitstreams over a period of time, thereby enabling continuing active communication between PD 150 and, for example, PSE 120.

Referring to step 240 of the method embodied in FIG. 2, step 240 of flowchart 200 comprises controller 152 coupling load 118 to power line 112 using load switch 158. For example, a received bitstream may include notification that a requested supply power will be available for a particular period of time. Upon receiving such notification, controller 152 may be configured to close load switch 158, for example, and couple load 118 to power line output 154 to power load 118, for example, at the requested supply power for the particular period of time. In some embodiments, such active management data may allow PSE 120, for example, to allocate power among multiple additional devices (not explicitly shown in FIG. 1), similar to PD 150 and load 118 for instance, coupled to system 100.

Continuing with step 250 in FIG. 2, step 250 of flowchart 200 comprises controller 152 providing a second bitstream to current modulator 160 coupled to power line 112. For example, modulator 162 of current modulator 160 may be configured to accept a bitstream from controller 152. In some embodiments, such accepted bitstream may comprise a requested supply power, an identification data, or a received supply power, for example, as explained above.

Moving to step 260 in FIG. 2, step 260 of flowchart 200 comprises controller 152 modulating a second portion of power signal 116 using current modulator 160. As described previously, in some embodiments, modulator 162 of current modulator 160 may be configured to encode a supplied bitstream into a modulated control signal provided to variable current source 164, for example, which may then produce a corresponding modulated current enabling current modulation of at least a second portion of power signal 116 and, in subsequent steps, transmission of the bitstream over power line 112. Similar to above, by being configured to repeat steps 250 and 260 periodically, for example, embodiments of the present inventive concepts may be able to transmit multiple bitstreams over a period of time, for instance, thereby enabling continuing active communication between PD 150 and, for example, PSE 120.

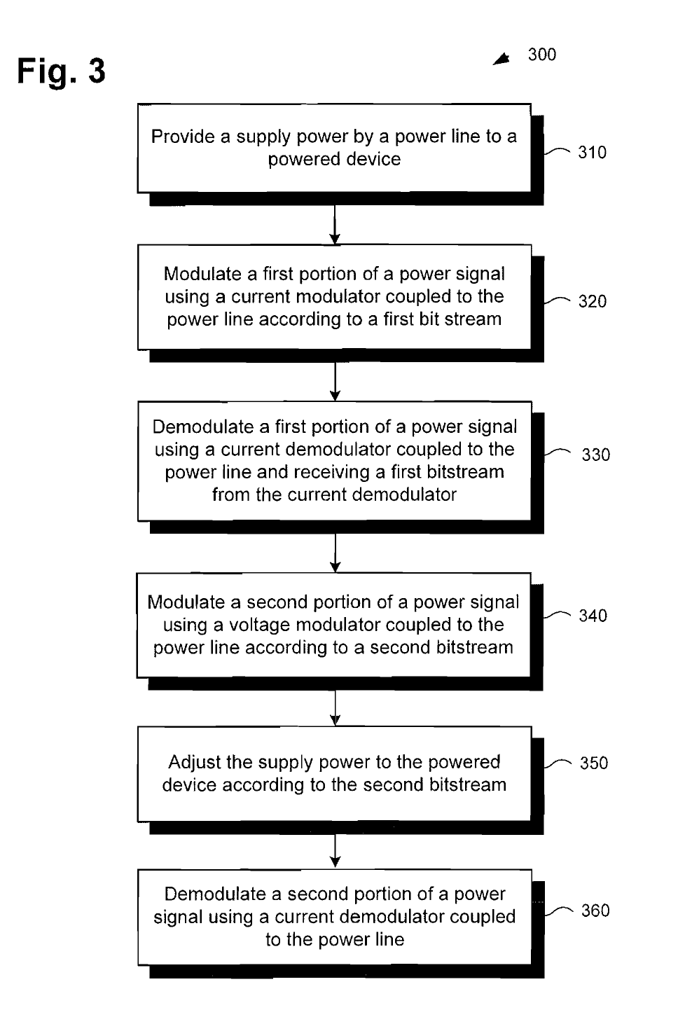

Turning to FIG. 3, FIG. 3 shows flowchart 300 illustrating a method for a controller of a PSE and a controller of a PD for two-way communication via a power line, such as controller 152 of PD 150 and controller 122 of PSE 120 communicating via power line 112 with each other, for example. Certain details and features have been left out of flowchart 300 that are apparent to a person of ordinary skill in the art. For example, a step may consist of one or more substeps or may involve specialized equipment or materials, as known in the art. Steps 310 through 360 indicated in flowchart 300 are sufficient to describe one embodiment of the present invention; however, other embodiments of the invention may make use of steps different from those shown in flowchart 300. It is noted that FIG. 1 also illustrates a system capable of performing the method of flowchart 300, and so steps 310 through 360 are described with reference to system 100 in FIG. 1.

Referring now to step 310 of the method embodied in FIG. 3, step 310 of flowchart 300 is the same as step 210 of FIG. 2, comprising controller 122 providing supply power 114 through programmable power supply 110 via power line 112 to PD 150. For example, controller 122 may be configured to communicate with programmable power supply 110 to provide supply power 114, for example, when power line 112 is connected to PD 150, for instance, utilizing power line output 154 and power line input 156.

Continuing with step 320 in FIG. 3, step 320 of flowchart 300 comprises controller 152 modulating a second portion of power signal 116 using current modulator 160 coupled to power line 112. Such second portion may be differentiated from other portions of power signal 116, for example, utilizing any differentiation method that can be used to facilitate two-way communications between devices coupled to power line 112. Furthermore, any type of modulation method may be used by modulator 162 of current modulator 160, for example, that can produce a current modulation encoded according to a first bitstream provided by controller 152.

Continuing with step 330 in FIG. 3, step 330 of flowchart 300 comprises controller 122 demodulating a second portion of power signal 116 using current demodulator 130 coupled to power line 112 in order to receive a first bitstream. Any type of demodulation method may be used by demodulator 134 of current demodulator 130, for example, that can produce a first bitstream encoded in a current modulation sensed by current sensor 132. By being configured to repeat steps 320 and 330 periodically, for example, embodiments of the present inventive concepts may send and receive multiple bitstreams over a period of time, thereby enabling continuing active communication between PD 150 and, for example, PSE 120.

Continuing with step 340 in FIG. 3, step 340 of flowchart 300 comprises controller 122 modulating a first portion of power signal 116 using voltage modulator 140 coupled to power line 112. Such first portion may be differentiated from other portions of power signal 116, for example, utilizing any differentiation method that can be used to facilitate two-way communications between devices coupled to power line 112. Furthermore, any type of modulation method may be used by modulator 142 of voltage modulator 140, for example, that can produce a voltage modulation encoded according to a second bitstream provided by controller 122.

Continuing with step 350 in FIG. 3, step 350 of flowchart 300 comprises controller 122 adjusting the supply voltage provided by programmable power supply 110 according to the second bitstream, which may be transmitted from controller 122 to programmable power supply 110 via control line 128.

Continuing with step 360 in FIG. 3, step 360 of flowchart 300 comprises controller 152 demodulating a first portion of power signal 116 using complex demodulator 170 coupled to power line 112. As explained above, such first portion may be differentiated from other portions of power signal 116, for example, utilizing any differentiation method that can be used to facilitate two-way communications between devices coupled to power line 112. Furthermore, any type of demodulation method may be used by demodulator 174 of complex demodulator 170, for example, that can produce a bitstream encoded in a voltage modulation sensed by voltage sensor 172, or optionally, a bitstream encoded in a current modulation sensed by current sensor 176. Similar to above, by being configured to repeat steps 340 and 350 periodically, for example, embodiments of the present inventive concepts may be able to transmit and receive multiple bitstreams over a period of time, for instance, thereby enabling continuing active communication between PSE 120 and, for example, PD 150.

Thus, embodiments of the present inventive concepts provide an inexpensive and simple to implement communication protocol for communication via a power line that supports active communication of detailed operational data between powering and powered devices without having to rely on separate data lines and communication protocols or particular powered states.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A power supply equipment (PSE) for communication via a power line, the PSE comprising:
a controller;
a power line input coupled to the power line;
a current demodulator coupled to the power line input and the controller;
the controller being configured to demodulate a first portion of a power signal of the power line at the power line input using the current demodulator and receive a first bitstream over the power line.

2. The PSE of claim 1, wherein the current demodulator comprises a current sensor coupled to the power line input and a demodulator coupled to the current sensor and the controller.

3. The PSE of claim 1, further comprising:
a voltage modulator coupled to the power line input and the controller;
the controller being further configured to modulate a second portion of the power signal using the voltage modulator and transmit a second bitstream over the power line.

4. The PSE of claim 1, further comprising:
a voltage modulator coupled to the power line input and the controller and comprising a switch resistance modulator;
the switch resistance modulator being configured to modulate a switch resistance coupled to the power line input and a voltage sink;
the controller being further configured to modulate a second portion of the power signal using the voltage modulator and transmit a second bitstream over the power line.

5. The PSE of claim 1, further comprising:
a voltage modulator coupled to the power line input and the controller and comprising a variable voltage source coupled to a gate of a transistor;
a source and drain of the transistor being coupled to the power line input and a voltage sink;
the controller being further configured to modulate a second portion of the power signal using the voltage modulator and transmit a second bitstream over the power line.

6. The PSE of claim 1, wherein the first bitstream comprises a requested supply power and the controller is additionally coupled to a programmable power supply that is coupled to the power line;
the controller being further configured use the programmable power supply to produce the requested supply power for the power line.

7. The PSE of claim 1, wherein the first bitstream comprises an identification data and the controller is additionally coupled to a programmable power supply that is coupled to the power line;
the controller being further configured use the identification data and the programmable power supply to produce a supply power associated with the identification data for the power line,

8. The PSE of claim 1, wherein the first bitstream comprises a received supply power;
the controller being further configured use the received supply power to calculate a cable loss of the power line.

9. A powered device (PD) for communication via a power line, the PD comprising:
a controller;
a power line input and a power line output coupled to the power line;
a current modulator coupled to the power line input, the power line output and the controller;
the controller being configured to modulate a first portion of a power signal of the power line at the power line output using the current modulator and transmit a first bitstream over the power line.

10. The PD of claim 9, wherein the current modulator comprises a variable current source coupled to the power line input and the power line output and a modulator coupled to the variable current source and the controller.

11. The PD of claim 9, further comprising:
a voltage demodulator coupled to the power line input, the power line output and the controller;
the controller being further configured to demodulate a second portion of the power signal using the voltage demodulator and receive a second bitstream over the power line.

12. The PD of claim 9, further comprising:
a voltage demodulator coupled to the power line input, the power line output and the controller, the voltage demodulator comprising a voltage sensor coupled to the power line input and the power line output and a demodulator coupled to the voltage sensor and the controller;
the controller being further configured to demodulate a second portion of the power signal using the voltage demodulator and receive a second bitstream over the power line.

13. The PD of claim 9, wherein the first bitstream comprises a requested supply power.

14. The PD of claim 9, wherein the first bitstream comprises an identification data, the identification data associated with a supply power for the PD.

15. The PD of claim 9, wherein the first bitstream comprises a received supply power.

16. The PD of claim 9, further comprising:
a load switch coupled to the controller and configured to selectively couple a load to the power line;
the controller being further configured to be capable of coupling the load to the power line using the load switch.

17. A method for execution by a controller of a powered device (PD) for communication via a power line, the method comprising:
sensing a supply power provided by a power line to the PD;
demodulating a first portion of a power signal using a voltage demodulator coupled to the power line;
receiving a first bitstream from the voltage demodulator.

18. The method of claim 17, further comprising:
providing a second bitstream to a current modulator coupled to the power line;
modulating a second portion of a power signal using the current modulator.

19. The method of claim 17, further comprising:
coupling a load to the power line using a load switch coupled to the controller.

20. The method of claim 17, wherein the first bitstream comprises a data selected from the group consisting of a requested supply power, an identification data, and a received supply power.

21. A method for execution by a controller of a power supply equipment (PSE) device for communication via a power line, the method comprising:
providing supply power to a powered device (PD);
demodulating a second portion of a power signal using a current demodulator coupled to a power line;
receiving a first bitstream from the current demodulator.

22. The method of claim 21, further comprising:
providing a second bitstream to a voltage modulator coupled to the power line;
modulating a first portion of a power signal using the voltage modulator.

23. The method of claim 21, further comprising:
adjusting the supply power to the PD according to the received bitstream.

24. The method of claim 21 wherein the supply power is configured to provide DC or AC power to the PD.
